(19) United States
(12) Patent Application Publication
(10) Pub. No.: US 2019/0086772 A1
(43) Pub. Date: Mar. 21, 2019

(54) OUTDOOR SECURITY SYSTEMS AND METHODS

(71) Applicant: SkyBell Technologies, Inc., Irvine, CA (US)

(72) Inventor: Joseph Frank Scalisi, Yorba Linda, CA (US)

(21) Appl. No.: 16/055,115

(22) Filed: Aug. 5, 2018

Related U.S. Application Data
(60) Provisional application No. 62/560,118, filed on Sep. 18, 2017.

(51) Int. Cl. G03B 17/08; H04N 7/18; H04N 5/225

(52) U.S. Cl. CPC G03B 17/08; H04N 5/2252; H04N 5/2256; H04N 7/183

(57) ABSTRACT

The disclosure includes a weatherproof security system comprising a housing, a light, a camera, and a visual adjustment device, such as a mirror or a lens. The visual adjustment device may allow the camera to capture images along a radial direction around the security device. In some embodiments, the camera is located adjacent a bottom end of the housing and facing upward, while in some embodiments the camera is located adjacent a top end of the housing and facing downward.

### CROSS-REFERENCE TO RELATED APPLICATIONS

This application claims the benefit of U.S. Provisional Patent Application No. 62/560,118, filed Sep. 18, 2017; entitled OUTDOOR SECURITY SYSTEMS AND METHODS; and having an attorney docket number SKYBELL.110P. The entire contents of U.S. Patent Application No. 62/560,118 are incorporated by reference herein.

### BACKGROUND

### Field

Various embodiments disclosed herein relate to security systems. Certain embodiments relate to weatherproof security systems located in outdoor spaces.

### Description of Related Art

Homes, offices, and other buildings sometimes include security systems to enable occupants of the buildings to remotely monitor their premises to deter and prevent unwanted visitors. One shortcoming of such security systems is that they are easily noticeable and therefore avoidable by perpetrators. Thus, there is a need for undiscernable security sytems and methods to monitor the premises.

### SUMMARY

This disclosure includes a security system comprising a weatherproof security device including a housing elongate along a first direction. The housing may comprise a top end, a bottom end located opposite the top end, and a hollow inner portion. The security device may include a light coupled to the housing and located within the hollow inner portion adjacent the bottom end. The light may face towards the top end. The security device may also include a camera coupled to the housing. The camera may face towards at least one of the top end and the bottom end. The security device may include a visual adjustment device coupled to the housing and aligned with an optical axis of the camera. The visual adjustment device may be arranged and configured to allow the camera to capture images along a radial direction around the security device. The radial direction may be perpendicular to the first direction.

In some embodiments, the visual adjustment device is located closer to the top end than the bottom end. In some embodiments, the visual adjustment device is coupled to the top end and the camera is located closer to the bottom end than the top end and the camera faces the top end. The camera may be located closer to the top end than the bottom end and the camera may face the bottom end.

The visual adjustment device may comprise at least one of a mirror and lens. In some embodiments, the visual adjustment device comprises a cone-shaped mirror that radially extends at least 90-degrees around a perimeter of the camera so that the camera captures images at least 90-degrees around a perimeter of the housing along a second direction that is perpendicular to the first direction. As well, in some embodiments, the visual adjustment device comprises a cone-shaped mirror that radially extends at least 180-degrees around a perimeter of the camera so that the camera captures images at least 180-degrees around a perimeter of the housing along a second direction that is perpendicular to the first direction. Even still, in some embodiments, the visual adjustment device comprises a cone-shaped mirror that radially extends 360-degrees around a perimeter of the camera so that the camera captures images 360-degrees around a perimeter of the housing along a second direction that is perpendicular to the first direction.

The security system may also include a remote computing device communicatively coupled to the camera and/or the security device. The weatherproof security device may be a first weatherproof security device and the system may further comprise a second weatherproof security device communicatively coupled to at least one of the first weatherproof security device and the remote computing device. The remote computing device may be a first remote computing device and the system may further include a second remote computing device communicatively coupled to at least one of the weatherproof security device and the first remote computing device. Even still, the weatherproof security device may be a first weatherproof security device and the system may further comprise a second weatherproof security device communicatively coupled to at least one of the first weatherproof security device, the first remote computing device, and the second remote computing device.

The weatherproof security device may further comprise a microphone coupled to the housing and a speaker coupled to the housing. The microphone and speaker may be arranged and configured to enable two-way communication between the weatherproof security device and the remote computing device. In some embodiments, the light is coupled to the housing via a low voltage electrical connection whereby the light receives electrical power from the low voltage electrical connection.

The camera may be coupled to the housing via a low voltage electrical connection wherein the camera receives electrical power from the low voltage electrical connection. The security system may further include a low voltage electrical cable and plug extending from the housing. At least one of the light and the camera may receive electrical power from the low voltage electrical cable and plug.

In some embodiments, the housing comprises a tube elongate along the first direction, and a base coupled to the elongate tube. The base may be rotatably coupled to the tube. In some embodiments, the base further comprises at least one aperture extending through the base such that moisture is able to escape the hollow inner portion of the housing. Even still, the system may further comprise a stake extending from the base along a third direction opposite the first direction.

Furthermore, in some embodiments, the visual adjustment device is rotatably coupled to the housing. As well, the camera and the light may be slideably coupled to the housing. The security system may further comprise a transparent material radially extending around the visual adjustment device. The transparent material may comprise at least one of glass, plastic, polycarbonate, and acrylic.

The security system may include a wireless communication module coupled to the housing. The wireless communication module may comprise at least one of a Wi-Fi extender, Wi-Fi booster, and Wi-Fi repeater. The wireless communication module may be coupled to the housing via a low voltage electrical connection. The wireless communication module may receive electrical power from the low voltage electrical connection.

In some embodiments, the system includes an antenna communicatively coupled to the wireless communication module. The antenna may be coupled to an outer surface of the housing. As well, the antenna may be located within the hollow inner portion. The disclosure also includes a low voltage security device that includes a housing, a camera coupled to the housing, and a low voltage electrical connection coupled to the housing and electrically coupled to the camera. In some embodiments, the security device further includes a wireless communication module coupled to the housing and communicatively coupled to the camera. The wireless communication module may be arranged and configured to transmit images captured by the camera to a remote computing device.

The low voltage electrical connection may comprise a male connection configured to electrically couple to a low voltage female connection. Even still, the low voltage electrical connection may comprise a female connection configured to electrically couple to a low voltage male connection. The security device may include a light coupled to the housing. In this regard, the low voltage electrical connection may be electrically coupled to the light.

The disclosure also includes a wireless communication system comprising a weatherproof housing, a Wi-Fi extender coupled to the weatherproof housing, and a low voltage electrical connection coupled to the weatherproof housing and electrically coupled to the Wi-Fi extender. The system may further comprise an antenna communicatively coupled to the Wi-Fi extender. In some embodiments, the antenna is coupled to an outer surface of the weatherproof housing. Even still, in some embodiments, the antenna is located within an inner portion of the weatherproof housing.

The embodiments described above include many optional features and aspects. Features and aspects of the embodiments can be combined.

### BRIEF DESCRIPTION OF THE DRAWINGS

These and other features, aspects, and advantages are described below with reference to the drawings, which are intended to illustrate, but not to limit, the invention. In the drawings, like reference characters denote corresponding features consistently throughout similar embodiments.

FIG. 1 illustrates a front view of a security device, according to some embodiments.

FIGS. 2 and 3 illustrate front views of security devices having a camera and an optical axis, according to some embodiments.

FIGS. 4a, 4b, and 4c illustrate top views of visual adjustment devices, according to some embodiments.

FIG. 5 illustrates a security device and a remote computing device, according to some embodiments.

FIG. 6 illustrates first and second security devices and first and second remote computing devices, according to some embodiments.

FIG. 7 illustrates an exploded view of a security device, according to some embodiments.

FIG. 8 illustrates a base of a security device, according to some embodiments.

FIGS. 9a and 9b illustrate housings of various security devices, according to some embodiments.

### DETAILED DESCRIPTION

Although certain embodiments and examples are disclosed below, inventive subject matter extends beyond the specifically disclosed embodiments to other alternative embodiments and/or uses, and to modifications and equivalents thereof. Thus, the scope of the claims appended hereto is not limited by any of the particular embodiments described below. For example, in any method or process disclosed herein, the acts or operations of the method or process may be performed in any suitable sequence and are not necessarily limited to any particular disclosed sequence. Various operations may be described as multiple discrete operations in turn, in a manner that may be helpful in understanding certain embodiments; however, the order of description should not be construed to imply that these operations are order dependent. Additionally, the structures, systems, and/or devices described herein may be embodied as integrated components or as separate components.

For purposes of comparing various embodiments, certain aspects and advantages of these embodiments are described. Not necessarily all such aspects or advantages are achieved by any particular embodiment. Thus, for example, various embodiments may be carried out in a manner that achieves or optimizes one advantage or group of advantages as taught herein without necessarily achieving other aspects or advantages as may also be taught or suggested herein.

Communication systems can provide a secure and convenient way for a remotely located individual to communicate with a person who is approaching a sensor, such as a proximity sensor or motion sensor, or with a person who rings a doorbell, which can be located in a doorway, near an entrance, or within 15 feet of a door. Some communication systems allow an individual to hear, see, and talk with visitors who approach at least a portion of the communication system and/or press a button, such as a doorbell's button. For example, communication systems can use a computing device to enable a remotely located person to see, hear, and/or talk with visitors. Computing devices can include computers, laptops, tablets, mobile devices, smartphones, cellular phones, and wireless devices (e.g., cars with wireless communication). Example computing devices include the iPhone, iPad, iMac, MacBook Air, and MacBook Pro made by Apple Inc. Communication between a remotely located person and a visitor can occur via the Internet, cellular networks, telecommunication networks, and wireless networks.

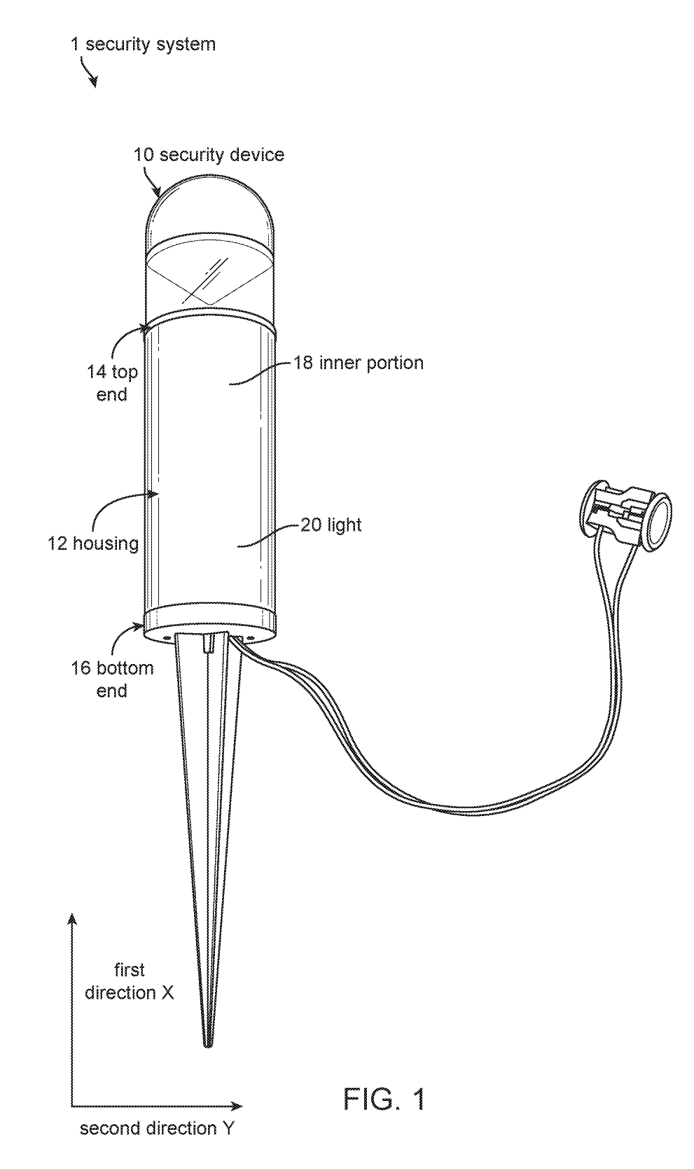

FIG. 1 illustrates a front view of a security system 1 comprising a weatherproof security device 10 that includes a housing 12 elongate along a first direction X. The housing 12 may comprise a top end 14, a bottom end 16 located opposite the top end 14, and a hollow inner portion 18. The security device 10 may also include a light 20 coupled to the housing 12 and located within the hollow inner portion 18 adjacent the bottom end 16. In some embodiments, the light 20 faces towards the top end 14.

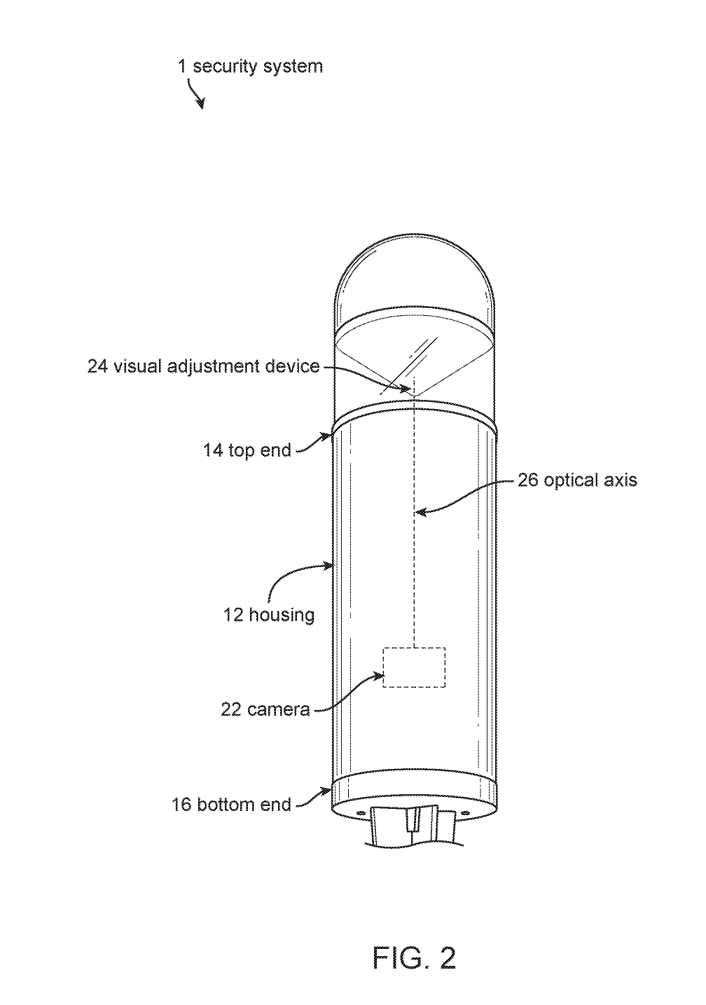

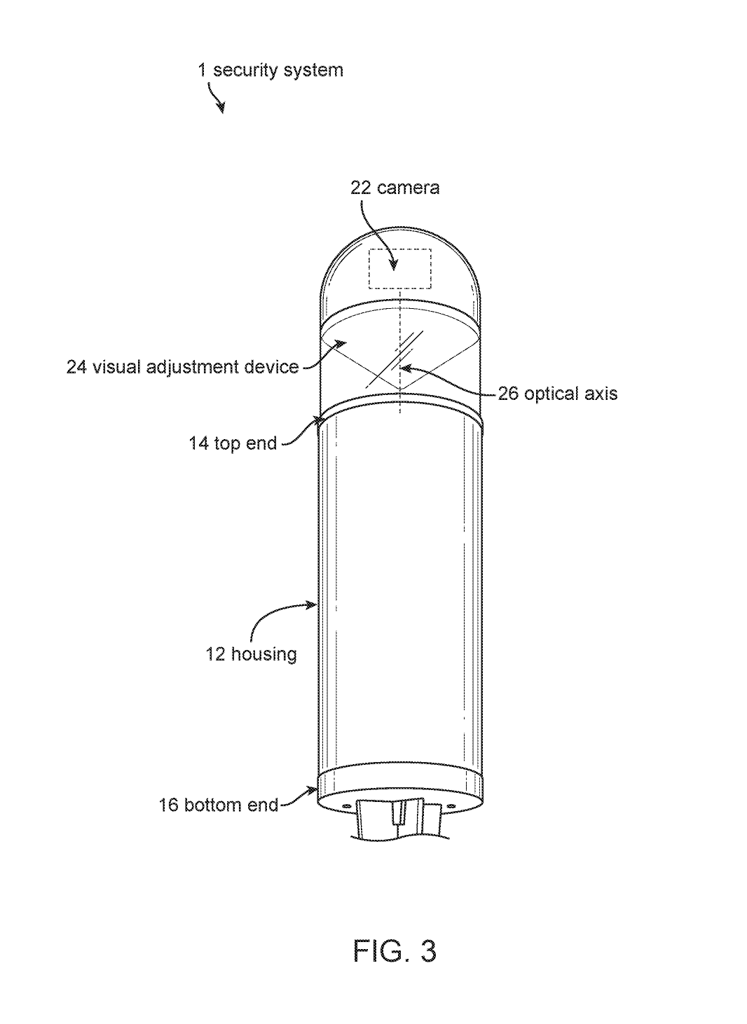

According to FIGS. 2 and 3, the security device 10 may also include a camera 22 coupled to the housing 12, and a visual adjustment device 24 coupled to the housing 12 and aligned with an optical axis 26 of the camera 22. The visual adjustment device 24 may be arranged and configured to allow the camera 22 to capture images along a radial direction (or second direction Y) around the security device 1. The visual adjustment device 24 may comprise a mirror and/or a lens, whereby either is arranged and configured to enhance the focus and/or capture images radially located around the security device. According to FIG. 1, the radial direction is perpendicular to the first direction X.

As shown in FIGS. 2 and 3, the visual adjustment device 24 may be located closer to the top end 14 than the bottom end 16. In some embodiments, the visual adjustment device 24 is directly or indirectly coupled to the top end 14. As shown in FIG. 2, the camera 22 may be located closer to the bottom end 16 than the top end 14. In this regard the camera 22 may face the top end 14 and/or the visual adjustment device 24. Alternatively, as shown in FIG. 3, the camera 22 may be located closer to the top end 14 than the bottom end 16. Accordingly, the camera 22 may face the bottom end 16 and/or the visual adjustment device 24. In many embodiments, the camera 22 faces the visual adjustment device 24 so that the camera 22 can capture images radially located around the security device 10.

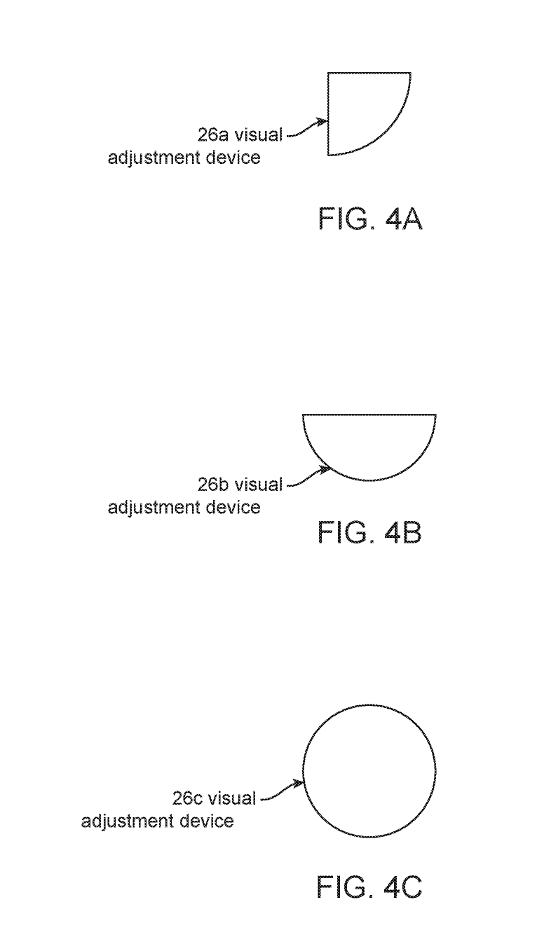

As shown in FIGS. 1-3, the visual adjustment device may define a cone-shape. As illustrated in the top-down view in FIG. 4a, the cone-shape may radially extend at least 90-degrees around a perimeter of the camera 22 so that the camera 22 captures images at least 90-degrees around a perimeter of the housing 12 along a second direction Y that is perpendicular to the first direction X. As shown in FIG. 4b, the cone-shape may radially extend at least 180-degrees around a perimeter of the camera 22 so that the camera 22 captures images at least 180-degrees around a perimeter of the housing 12 along the second direction Y. Even still, as illustrated in FIG. 4c, the cone-shape may radially extend 360-degrees around a perimeter of the camera 22 so that the camera 22 captures images 360-degrees around a perimeter of the housing 12 along the second direction Y.

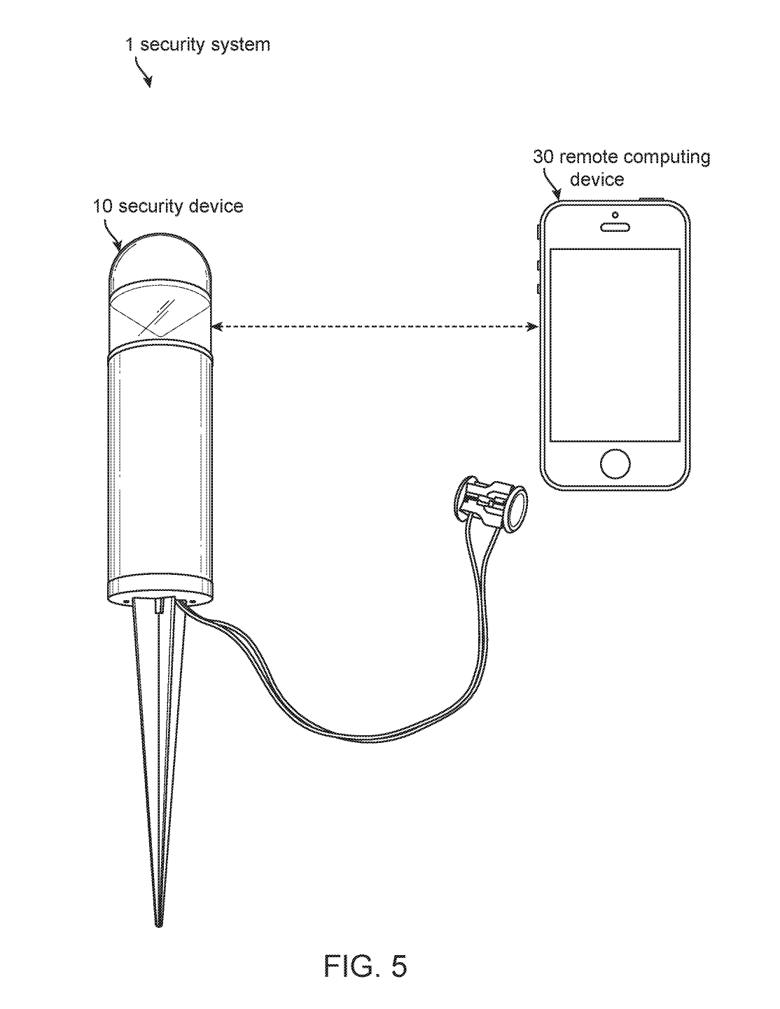

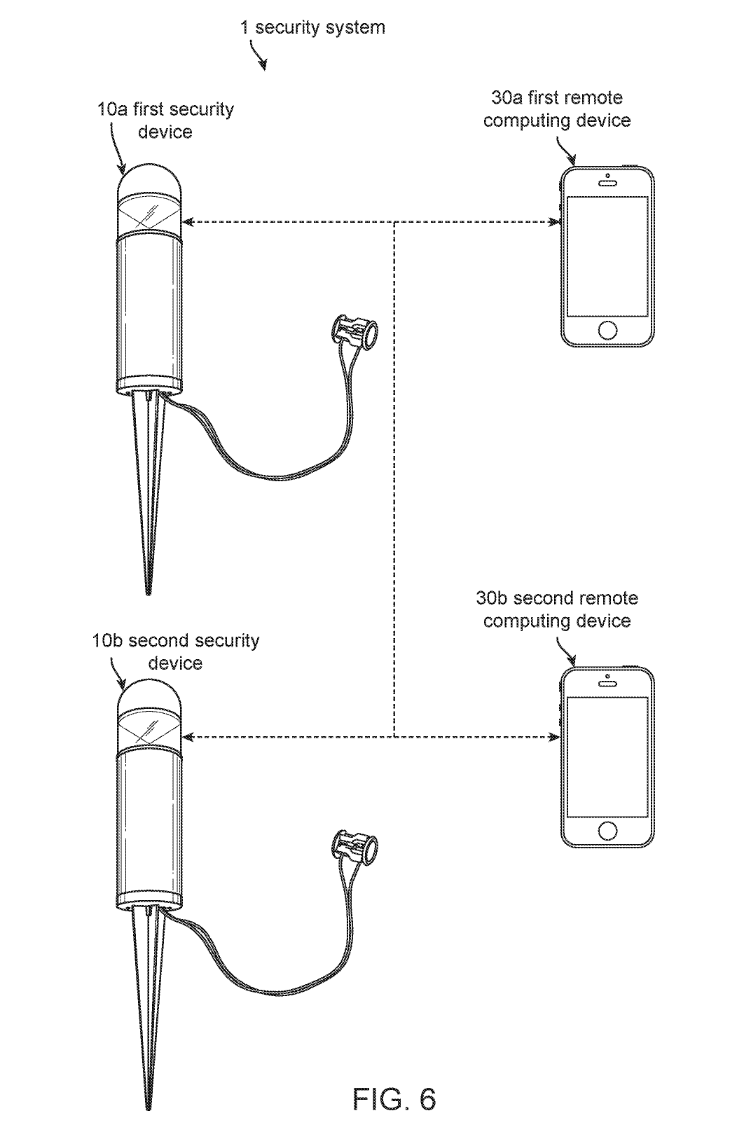

Now with reference to FIG. 5, the security system 1, may further include a remote computing device 30 communicatively coupled to the security device 10 and/or the camera 22. As shown in FIG. 6, in some embodiments, the system 1 may include first and second weatherproof security devices 10a, 10b communicatively coupled to first and second weatherproof security device 30a, 30b. It should be appreciated that any combination of first and second security devices 10a, 10b may be communicatively coupled to any combination of first and second remote computing devices 30a, 30b.

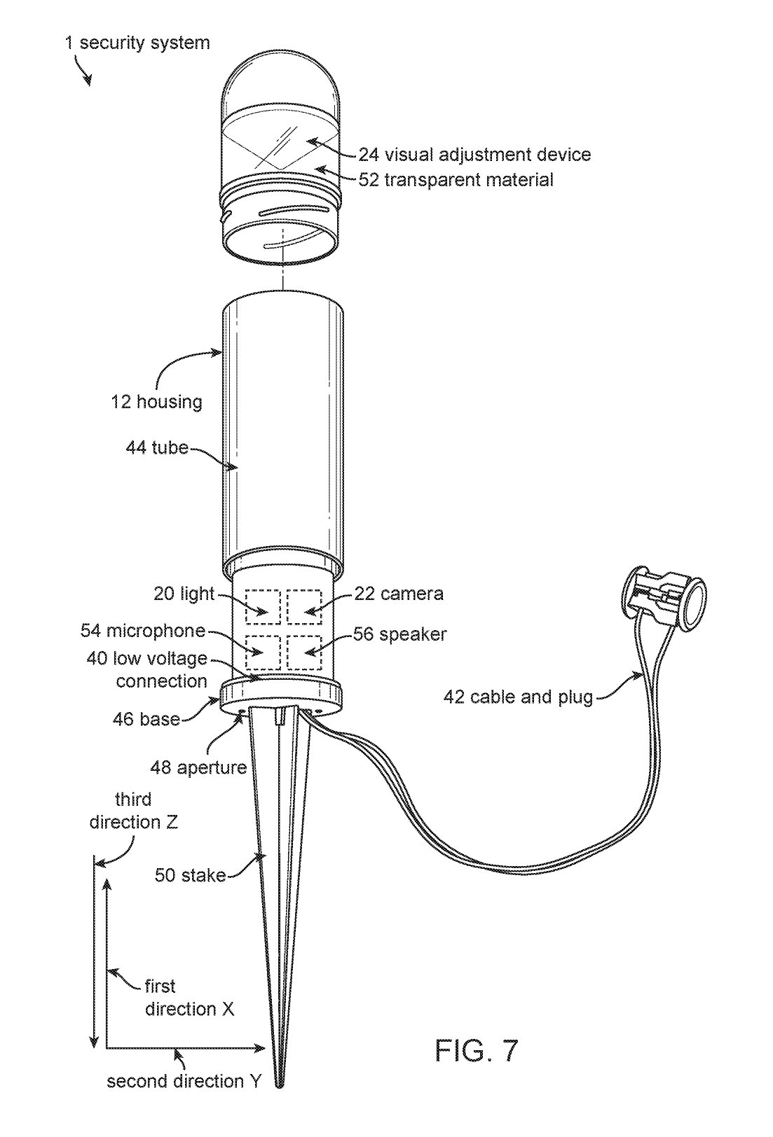

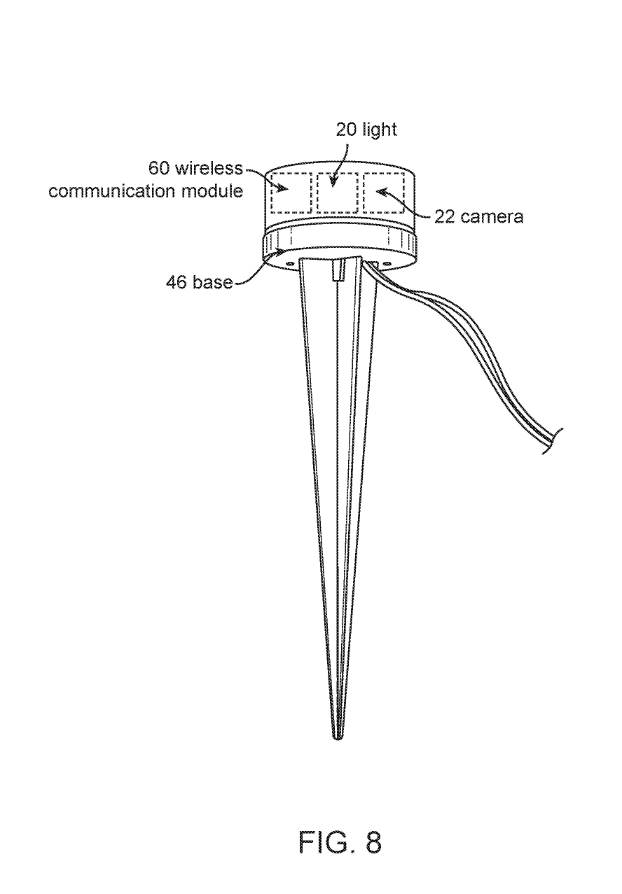

As shown in FIGS. 7, 8, 9a, and 9b, the security device 10 may include a microphone 54 coupled to the housing 12 and a speaker 56 coupled to the housing 12. The microphone 54 and speaker 56 may be arranged and configured to enable two-way communication between the security device 10 and the remote computing device 30.

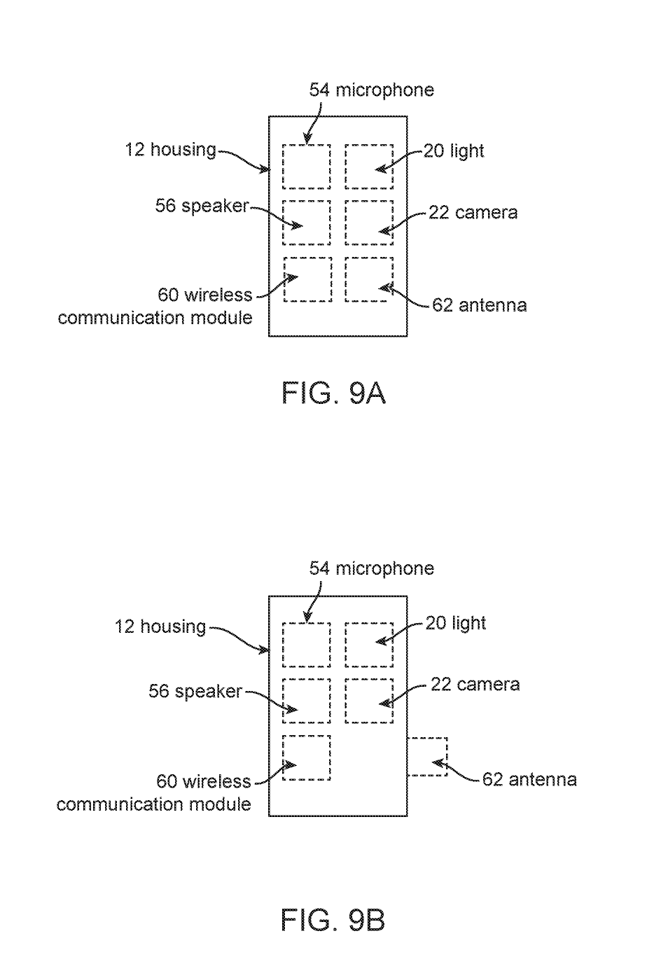

To enable communication between the security device 10 and other devices, such as remote computing devices 30, the security device 10 may comprise a wireless communication module 60 coupled to the housing 12. In some embodiments, the wireless communication module 60 comprises at least one of a Wi-Fi extender, Wi-Fi booster, and Wi-Fi repeater. The security device 10 may also include an antenna 62 communicatively coupled to the wireless communication module 60. As illustrated in FIG. 9a, the antenna 62 may be located within the hollow inner portion 18 of the housing 12. Even still, as shown in FIG. 9b, the antenna 62 may be coupled to an outer surface of the housing 12.

The security device 10 may be powered by a low voltage power supply transmitted through a low voltage electrical cable and plug 42 extending from the housing 12. Accordingly, any of the components, such as the light 20 and/or camera 22 may be coupled to the housing 12 via a low voltage electrical connection 40, whereby the light 20 and/or camera 22 may receive electrical power from the low voltage electrical connection 40.

As illustrated in FIG. 7, the housing 12 may include a tube 44 elongate along the first direction X and a base 46 coupled to the elongate tube 44. In some embodiments, the base 46 is rotatably coupled to the tube 44. Even still, in some embodiments, the base 46 further comprises at least one aperture 48 extending through the base 46 such that moisture is able to escape the hollow inner portion 18 of the housing 12. As well, the security device 10 may include a stake 50 extending from the base along a third direction Z opposite the first direction X.

The various components of the security device 10 may be coupled together via a variety of coupling mechanisms. For example, the visual adjustment device 24 may be rotatably coupled to the housing 12. As well, the camera 22 and light 20 may be slideably coupled to the housing 12, such as via a low voltage electrical connection (e.g. two electrical prongs).

With continued reference to FIG. 7, the security device 10 may further include a transparent material 52 that radially extends around the visual adjustment device 24. In some embodiments, the transparent material 52 is glass, plastic, polycarbonate, and/or acrylic.

It should be appreciated that the security device 10 may be implemented with any combination of components. In some embodiments, the security device 10 comprises a housing 12, a camera 22 coupled to the housing 12, and a low voltage electrical connection 40 coupled to the housing 12 and electrically coupled to the camera 22. Some embodiments may also include the wireless communication module 60 coupled to the housing 12 and communicatively coupled to the camera 22. In this regard, the wireless communication module 60 is arranged and configured to transmit images captured by the camera 22 to the remote computing device 30.

In some embodiments, the security device 10 is referred to as a wireless communication system that includes a weatherproof housing 12, a Wi-Fi extender 60 coupled to the weatherproof housing 12, and a low voltage electrical connection 40 coupled to the weatherproof housing 12 and electrically coupled to the Wi-Fi extender 60. In such embodiments, the wireless communication system may further include an antenna 62 communicatively coupled to the Wi-Fi extender 60.

The security device 10 may also include different types of low voltage electrical connections. In some embodiments, the low voltage electrical connection 40 comprises a male connection configured to electrically couple to a low voltage female connection. Alternatively, the low voltage electrical connection 40 comprises a female connection configured to electrically couple to a low voltage male connection. Accordingly, the components (e.g. light 20, camera 22, etc.) may be electrically coupled to the security device 10 via the opposite connection type. For example, if the security device 10 includes a female connection, then the light 20 may include a male connection.

### Interpretation

It should be appreciated that the term “security” may be used interchangeably with the term “surveillance.”

None of the steps described herein is essential or indispensable. Any of the steps can be adjusted or modified. Other or additional steps can be used. Any portion of any of the steps, processes, structures, and/or devices disclosed or illustrated in one embodiment, flowchart, or example in this specification can be combined or used with or instead of any other portion of any of the steps, processes, structures, and/or devices disclosed or illustrated in a different embodiment, flowchart, or example. The embodiments and examples provided herein are not intended to be discrete and separate from each other.

The section headings and subheadings provided herein are nonlimiting. The section headings and subheadings do not represent or limit the full scope of the embodiments described in the sections to which the headings and subheadings pertain. For example, a section titled “Topic 1” may include embodiments that do not pertain to Topic 1 and embodiments described in other sections may apply to and be combined with embodiments described within the “Topic 1” section.

Some of the devices, systems, embodiments, and processes use computers. Each of the routines, processes, methods, and algorithms described in the preceding sections may be embodied in, and fully or partially automated by, code modules executed by one or more computers, computer processors, or machines configured to execute computer instructions. The code modules may be stored on any type of non-transitory computer-readable storage medium or tangible computer storage device, such as hard drives, solid state memory, flash memory, optical disc, and/or the like. The processes and algorithms may be implemented partially or wholly in application-specific circuitry. The results of the disclosed processes and process steps may be stored, persistently or otherwise, in any type of non-transitory computer storage such as, e.g., volatile or non-volatile storage.

The various features and processes described above may be used independently of one another, or may be combined in various ways. All possible combinations and subcombinations are intended to fall within the scope of this disclosure. In addition, certain method, event, state, or process blocks may be omitted in some implementations. The methods, steps, and processes described herein are also not limited to any particular sequence, and the blocks, steps, or states relating thereto can be performed in other sequences that are appropriate. For example, described tasks or events may be performed in an order other than the order specifically disclosed. Multiple steps may be combined in a single block or state. The example tasks or events may be performed in serial, in parallel, or in some other manner. Tasks or events may be added to or removed from the disclosed example embodiments. The example systems and components described herein may be configured differently than described. For example, elements may be added to, removed from, or rearranged compared to the disclosed example embodiments.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations and so forth. Also, the term “or” is used in its inclusive sense (and not in its exclusive sense) so that when used, for example, to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require at least one of X, at least one of Y, and at least one of Z to each be present.

The term “and/or” means that “and” applies to some embodiments and “or” applies to some embodiments. Thus, A, B, and/or C can be replaced with A, B, and C written in one sentence and A, B, or C written in another sentence. A, B, and/or C means that some embodiments can include A and B, some embodiments can include A and C, some embodiments can include B and C, some embodiments can only include A, some embodiments can include only B, some embodiments can include only C, and some embodiments include A, B, and C. The term “and/or” is used to avoid unnecessary redundancy.

While certain example embodiments have been described, these embodiments have been presented by way of example only, and are not intended to limit the scope of the inventions disclosed herein. Thus, nothing in the foregoing description is intended to imply that any particular feature, characteristic, step, module, or block is necessary or indispensable. Indeed, the novel methods and systems described herein may be embodied in a variety of other forms; furthermore, various omissions, substitutions, and changes in the form of the methods and systems described herein may be made without departing from the spirit of the inventions disclosed herein.

1. A security system comprising a weatherproof security device including:
a housing elongate along a first direction, the housing comprising a top end, a bottom end located opposite the top end, and a hollow inner portion;
a light coupled to the housing and located within the hollow inner portion adjacent the bottom end, wherein the light faces towards the top end;
a camera coupled to the housing, wherein the camera faces towards the top end; and
a visual adjustment device coupled to the housing and aligned with an optical axis of the camera, wherein the visual adjustment device is arranged and configured to allow the camera to capture images along a radial direction around the security device, wherein the radial direction is perpendicular to the first direction.

2. The security system of claim 1, wherein the visual adjustment device is coupled to the top end.

3. The security system of claim 2, wherein the camera is located closer to the bottom end than the top end.

4. The security system of claim 2, wherein the camera is located closer to the top end than the bottom end.

5. The security system of claim 1, wherein the visual adjustment device comprises at least one of a mirror and lens.

6. The security system of claim 5, wherein the visual adjustment device comprises a cone-shaped mirror that radially extends at least 90-degrees around a perimeter of the camera so that the camera captures images at least 90-degrees around a perimeter of the housing along a second direction that is perpendicular to the first direction.

7. The security system of claim 5, wherein the visual adjustment device comprises a cone-shaped mirror that radially extends at least 180-degrees around a perimeter of the camera so that the camera captures images at least 180-degrees around a perimeter of the housing along a second direction that is perpendicular to the first direction.

8. The security system of claim 5, wherein the visual adjustment device comprises a cone-shaped mirror that radially extends 360-degrees around a perimeter of the camera so that the camera captures images 360-degrees around a perimeter of the housing along a second direction that is perpendicular to the first direction.

9. The security system of claim 1, further comprising a remote computing device communicatively coupled to the camera.

10. The security system of claim 9, wherein the weatherproof security device is a first weatherproof security device, and the remote computing device is a first remote computing device, the system further comprising:
a second weatherproof security device communicatively coupled to at least one of the first weatherproof security device, the first remote computing device, and a second remote computing device; and
the second remote computing device communicatively coupled to at least one of the first weatherproof security device, the second weatherproof security device, and the first remote computing device.

11. The security system of claim 9, wherein the weatherproof security device further comprises a microphone coupled to the housing and a speaker coupled to the housing, wherein the microphone and speaker are arranged and configured to enable two-way communication between the weatherproof security device and the remote computing device.

12. The security system of claim 1, wherein the light is coupled to the housing via a low voltage electrical connection, and the light receives electrical power from the low voltage electrical connection, wherein the camera is coupled to the housing via a low voltage electrical connection, and the camera receives electrical power from the low voltage electrical connection, the system further comprising a low voltage electrical cable and plug extending from the housing, wherein at least one of the light and camera receives electrical power from the low voltage electrical cable and plug.

13. The security system of claim 1, wherein the housing comprises:
a tube elongate along the first direction;
a stake extending from the base along a third direction opposite the first direction; and
a base coupled to the elongate tube, wherein the base is rotatably coupled to the tube and the base further comprises at least one aperture extending through the base such that moisture is able to escape the hollow inner portion of the housing.

14. The security system of claim 1, wherein the visual adjustment device is rotatably coupled to the housing, and the camera and light are slideably coupled to the housing.

15. The security system of claim 1, further comprising a transparent material radially extending around the visual adjustment device, wherein the transparent material comprises at least one of glass, plastic, polycarbonate, and acrylic.

16. The security device of claim 1, further comprising a wireless communication module coupled to the housing, wherein the wireless communication module comprises at least one of a Wi-Fi extender, Wi-Fi booster, and Wi-Fi repeater, wherein the wireless communication module is coupled to the housing via a low voltage electrical connection, and wherein the wireless communication module receives electrical power from the low voltage electrical connection, the system further comprising an antenna communicatively coupled to the wireless communication module.

17. The security system of claim 16, wherein the antenna is coupled to an outer surface of the housing.

18. The security system of claim 16, wherein the antenna is located within the hollow inner portion.

19. A low voltage security device, comprising:
a weatherproof housing;
a camera coupled to the weatherproof housing;
a low voltage electrical connection coupled to the weatherproof housing and electrically coupled to the camera;
a wireless communication module coupled to the weatherproof housing and communicatively coupled to the camera, wherein the wireless communication module is arranged and configured to transmit images captured by the camera to a remote computing device; and
a light coupled to the housing, wherein the low voltage electrical connection is electrically coupled to the light.

20. (canceled)

21. The security system of claim 2, wherein the camera faces away from the bottom end.
